(19) United States
(12) Patent Application Publication
(10) Pub. No.: US 2011/0181680 A1
(43) Pub. Date: Jul. 28, 2011

(54) METHOD FOR LASER MARKING AND DEVICE FOR CARRYING OUT SAID METHOD

(75) Inventors: Gert Teschauer, Chemnitz (DE); Matthias Weissbeck, Callenberg (DE)

(73) Assignee: Gordon Verwaltung GmbH, Chemnitz (DE)

(21) Appl. No.: 12/998,227

(22) PCT Filed: Sep. 29, 2009
(86) PCT No.: PCT/EP2009/062566

§ 371 Date: Apr. 11, 2011

(30) Foreign Application Priority Data
Sep. 30, 2008 (DE) 20 2008 013 199.5
Feb. 26, 2009 (DE) 10 2009001 205.2

(51) Int. Cl. B41J 2/44

(52) U.S. Cl. 347/248

(57) ABSTRACT

The invention relates to a method and device for the laser marking of workpieces (4) which are greater by at least one dimension than the inscription field (13) of laser inscription devices (1). A preferred field of application of the invention is the marking of elongate workpieces such as, for example, semiconductor columns for wafer production. The workpiece (4) is positioned in the laser inscription device in such a manner that the initial coordinates of a marking to be produced are situated within the inscription field of the laser inscription device. The laser beam is then guided by means of a beam guiding unit (12) in the inscription field (13) and a relative movement is carried out in at least one dimension between workpiece (4) and inscription field (13), which additively superimposes the beam guidance and is directed opposite to the beam deviation in the same dimension. The relative movement between workpiece and inscription field as well as the beam guidance are stopped when the end coordinates of the marking to be produced are reached and the workpiece is removed from the laser inscription device.

The invention refers to a process and a device for the laser-marking of work pieces that are in at least one dimension larger than the lettering area of laser-lettering devices. A preferred field of application of the invention is the marking of extended work pieces such as for instance semiconductor columns for the production of wafers. To qualify for a quality assurance in the production of such semiconductor columns, these are provided on a longitudinal side with a bar code and a testing code. The marking occurs by laser-lettering in the way that after sawing the wafers their thicknesses come to lie between 120 and 210 μm, the bar code is legible on the wafer edge and it becomes possible, by means of the testing code, to arrive at conclusions about the original position of the wafers along the length of the column.

The execution of coding semiconductor columns by laser lettering is known. However, the processing fields of the known solutions fail, because of the radiation sources and objectives which are among other things coordinated with each other in regard to their parameters of radiation quality M² on one side and focal length F on the other, to cover the full length of the columns, so that the marking only occurs in sections. This requires a lot of effort to maintain the necessary precision of the movable components, in order to avoid faulty passages between the processing fields leading to an unreadable coding. The German utility model DE 20 2008 013 199.5 points to a way of marking semiconductor columns of up to 500 mm length in the application-wise required manner, without repeated approaches. For this purpose, a laser lettering device consists of a laser source, a radiation guide and an objective. A transporting device and a controlling device are also provided, where the radiation quality M² of the laser source amounts to a maximum of 1.2 and an objective with a focal length f of 810 mm (at least 810 mm) is used. A position correcting device is provided, and the laser lettering device is endowed with a length measuring system.

This results in the invention's task of allowing the uninterrupted coding by laser-marking of work pieces that are even larger than the lettering field of the laser lettering device.

The invention solves this task by using a process for laser marking according to patent claim 1 and a device for executing the process according to patent claim 4. The work piece is positioned in the laser lettering device in such a manner that the initial coordinates of a marking to be applied fall within the lettering field of the laser lettering device, the laser ray is guided within the lettering field by using a radiation guiding unit and a relative motion between the work piece and the lettering field occurs in at least one dimension that is additively superimposed on the radiation guide and set up opposite to the deflection of the ray in the same dimension, the relative motion between the work piece and the lettering field as well as the radiation guide are halted upon attaining the final coordinates of the marking to be performed, and the work piece is extracted from the laser lettering device. The process according to the invention is advantageously further evolved by allowing at least one additional marking process to occur prior to extracting the work piece, whose initial coordinates are the final coordinates of the previous marking process, while the direction of the relative motion between the work piece and the lettering field is opposite to the direction of the relative motion of the previous marking process. This makes it possible to enhance the quality and intensity of the marking. Apart from this, the initial coordinate of a sequential marking process in a dimension orthogonal to the relative motion between the work piece and the lettering field can be changed in a manner to induce a change in the marking tracks, so that the marking can occur uninterruptedly in several sections. While changing the marking tracks, the laser ray emission itself may be interrupted. The inventive device for executing the process consists of at least one laser source, a radiation guiding unit and laser lettering device comprising an objective, a work piece transporting device and a controlling device connected to the radiation guiding unit and endowed with a system to detect the actual coordinate values. At least the work piece transporting device or the radiation guiding unit is conformed, in a manner movable in relation to the respective other device, by controllable drives connected to the controlling device. The controlling device is superimposed on the function of the radiation guide in the lettering field with the function of a relative motion between the work piece transporting device and the radiation guiding unit. The inventive device is advantageously conformed so that the radiation guiding unit is conformed as a scanner connected to the radiation source. Another advantageous conformation of the inventive device consists in the fact that the radiation guiding unit is conformed as at least one cutting tip connected to the radiation source through a flying optical system. The speed of the relative motion between the work piece and the lettering field is usually small compared to the speed of the radiation guide within the lettering field, so that the mass inertia deriving from the relative motion need only be considered at the ends of the tracks Suitable measures for these purposes are adequately known to a specialist, such as for instance a slow reduction of the displacing speed starting from an adequate distance before each end of the track.

The invention is in the following illustrated in greater detail in the form of a preferred example of an embodiment, with the aid of a drawing. The drawing shows in:

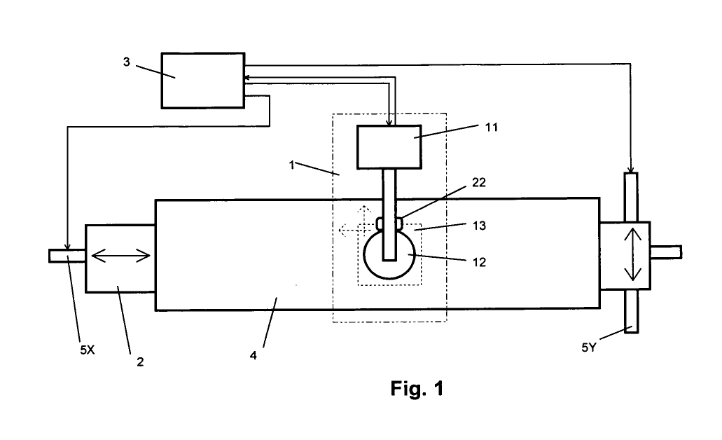

FIG. 1 A basic illustration of a marking device according to the invention in a topside view, and

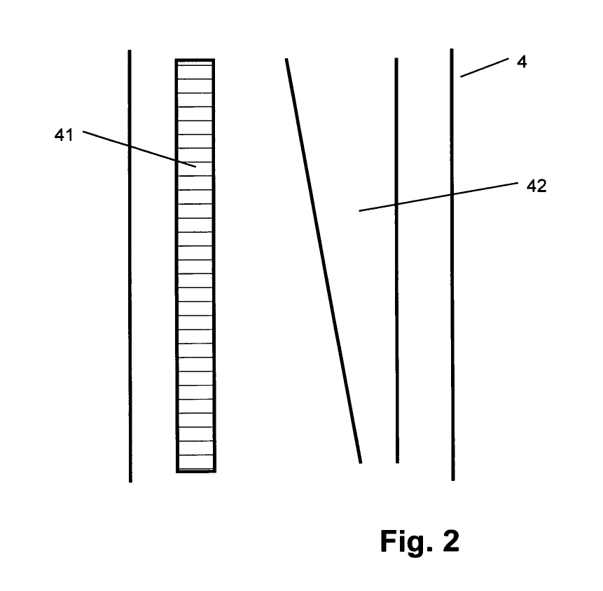

FIG. 2 The marking principle.

A marking device according to the invention for long semiconductor columns for the production of photovoltaic cells comprises according to FIG. 1 a laser lettering device 1 with a laser source 11, whose radiation emission occurs through a scanner 12 and an objective, not shown. The laser lettering device 1 is connected to a controlling computer 3, which is on the inlet side connected to a detecting system 22 for actual coordinate values. The detecting system 22 for actual coordinate values is set up next to the scanner 12, but may instead also be set up at any other suitable point. The scanner 12 is invested by the control signals of the computer 3, so that the radiation guiding takes place inside a lettering field 13. The radiation guiding occurs in a known manner by displacing the scanner level. The introduction of the semiconductor column 4 occurs by means of a transporting device 2, which can be positioned in 2 dimensions through two drives 5X and 5Y. The drives 5X and 5Y are invested by the controlling computer 3 with regulating signals, so as to regulate the distance and displacing speed in both axes. The relative motion thus realized between the semiconductor column 4 and the scanner 12 allows the marking of a surface delimited merely by the space conditions of the production track, and not also by the laser lettering device 1. In the preferred example of embodiment, this surface is the entire upper side, i.e. the side directed toward the radiation outlet of the semiconductor column 4 or any selected section thereof, while repeatedly moving the semiconductor column in a longitudinal direction to and fro under the scanner 12, where at any inversion point in an X-direction a one-track displacement may occur in a Y-direction, Such a change of track serves for instance to enlarge the last lettered markings or to inscribe further markings. If no displacement in a Y-direction occurs, the last lettered markings are for instance deepened or profiled by a further relative motion in an X-direction. The distance and speed signals for the drives 5X and 5Y are superimposed on the scanning control signals, so that the marking of the semiconductor column occurs faultlessly and uninterruptedly over its entire surface, meaning in a single stroke.

Through the marking device described above, the semiconductor columns 4 are provided on a longitudinal side with a coding according to FIG. 2. The coding comprises a bar code 41 applied to the longitudinal edge as well as a testing code 42, which forms a V-shaped code extending over the longitudinal side of the semiconductor column 4 and narrowing from a point next to the bar code track up to a point next to the opposite edge.

The process according to the invention allows the coding, while using the device according to the invention, to be applied to the semiconductor column 4 in a single stroke, according to FIG. 2. The individual lines of the bar code 41 and of the testing code 42 are generated in a continuous manner and without approaches, which improves, apart from enhancing the marking quality, the efficiency of the marking by shortening the time required for the same. Apart from utilizing a scanner 12, the invention also comprises the use of several scanners in parallel or of one or several cutting tips, which may occasionally be equipped with a flying optical system.

1. Process for the laser-marking of work pieces that are in at least one dimension larger than the lettering field (13) of a laser lettering device (1), wherein the work piece (4) is positioned in the laser lettering device (1) in such a manner that the initial coordinates of a marking to be applied come to lie within the lettering field (13) of the laser lettering device (1), the laser ray is guided in the lettering field (13) by means of a radiation guiding unit (12), a relative motion between the work piece (4) and the lettering field (13) occurs in at least one dimension that is superimposed on the radiation guiding unit 12 and set up opposite to the deflection of the ray in the same dimension, the relative motion between the work piece (4) and the lettering field (13) as well as the radiation guiding unit (12) is halted upon reaching the final coordinates of the marking to be performed, and the work piece (4) can be extracted from the laser lettering device (1).

1. Process according to claim 1, wherein at least one further marking process occurs before extracting the work piece (4), whose initial coordinates are the final coordinates of the previous marking process, where the direction of the relative motion between the second work piece (4) and the lettering field (13) is opposite to the direction of the relative motion of the previous marking process.

3. Process according to claim 2, wherein the initial coordinate of a sequential marking process in the dimension orthogonal to the dimension of the relative motion between the work piece (4) and the lettering field (13) is changed in such a manner that a change of the marking track occurs.

4. Device for executing the process according to claim 1 with at least one laser source (11), a radiation guiding unit (12) and laser lettering device (1) comprising an objective, a work piece transporting device (2) and a controlling device (3) connected with the radiation guiding source (12) and endowed with a detecting device (22) for the actual coordinate value, wherein at least the work piece transporting device (2) or the radiation guiding unit (12) is conformed in a movable manner with respect to the connectible controllable drives (5X, 5Y) and the controlling device (3) is superimposed on the function of the radiation guide in the lettering field (13) with the function of the relative motion between the work piece transporting device (2) and the radiation guiding unit (12).

5. Device according to claim 1, wherein the radiation guiding unit (12) is conformed as at least one scanner connected to the radiation source (11).

6. Device according to claim 4, wherein the radiation guiding unit (12) is conformed as at least one cutting tip connected to the radiation source (11) through a flying optical system.
